(19) United States
(12) Patent Application Publication
(10) Pub. No.: US 2021/0296016 A1
(43) Pub. Date: Sep. 23, 2021

(54) FUEL ASSEMBLY HANDLING DEVICE AND HANDLING ASSEMBLY COMPRISING SUCH A DEVICE

(71) Applicants: COMMISSARIAT A L'ENERGIE ATOMIQUE ET AUX ENERGIES ALTERNATIVES, PARIS (FR); SEIV, MERIGNAC (FR)

(72) Inventors: Bernard GUILLOU, SAINT-AUBIN DE MEDOC (FR); David ROUSSEAU, GRADIGNAN (FR)

(21) Appl. No.: 17/259,916

(22) PCT Filed: Jul. 10, 2019
(86) PCT No.: PCT/EP2019/068550

§ 371 Date: Jan. 12, 2021

(30) Foreign Application Priority Data
Jul. 24, 2018 (FR) 1856822

(51) Int. Cl. G21C 19/105; G21C 19/04; G21C 19/32

(52) U.S. Cl. CPC G21C 19/105; G21C 19/32; G21C 19/04

(57) ABSTRACT

A handling device for a nuclear fuel assembly includes a body; gripping means capable of cooperating with a fuel assembly so as to grasp or release the assembly; control means for controlling the gripping means capable of controlling the gripping means between a grasping position and a releasing position of the assembly, and vice versa; suction means capable of generating a suction of a cooling gas through the handling device and through the assembly when it is grasped by the device. A handling assembly for a nuclear fuel assembly, comprising: a handling device, a receiving support capable of receiving a fuel assembly and capable of cooperating with the handling device.

### TECHNICAL FIELD OF THE INVENTION

The invention relates to the field of nuclear fuel assembly handling.

The invention particularly targets the handling of assemblies for 4th generation fast neutron-type reactors.

The invention relates more specifically to a handling device, and an assembly comprising a handling device.

### STATE OF THE ART

In the field of the handling of fuel assemblies, particularly for assemblies coming from 4th generation fast neutron-type reactors, the fuels can reach residual thermal power levels of 30 to 40 kW on leaving the reactor. According to the constraints prescribed for the “ASTRID” (Advanced Sodium Technological Reactor for Industrial Demonstration) fourth generation fast neutron reactor, said fuels must then be cooled in a temporary storage location, for example a storage tank, until they reach a residual power of at most 3 kW to be able to be transferred into a hot cell.

A “hot cell” is a chamber intended to accommodate radioactive materials, capable of ensuring the containment of said materials and the protection against radiation by shielded walls. These are also called “high activity cell”.

The transfer of an assembly (more broadly of fuels) from a storage tank to a hot cell is generally performed using a specific grab used with a transfer hood (“hooded grab”) via a handling corridor between the storage tank and the hot cell.

A handling grab specific to the cell (“cell grab”) is then used. This grab must be compatible with a residual power of the order of 3 kW, that is to say with an assembly temperature that can reach 400° C., which can induce a temperature of the order of 150° C. when the cell grab makes contact with the assembly for it to be gripped.

The cell grab can also be called “handling system” or “handling device” hereinafter in the description.

The handling system must satisfy at least the following constraints:

gripping of a nuclear fuel assembly having dwelt in the core of a reactor, notably in a liquid sodium reactor;

handling capacity of the order of 600 kg;

connection and disconnection autonomy.

The handling system must observe other constraints, including:

thermal compatibility with the heat flux from the assembly transmitted by conduction at the assembly-handling system interface, and by convection (the flow of gas reheated on contact with the fuel heats up the grab);

handling safety: the handling system must not be connected or disconnected under load;

compatibility with ionizing radiations, notably emitted by the assembly, but also present in a hot cell;

compatibility with the environment and the remote handling constraints of the hot cell (remote operability);

compatibility with the presence of sodium;

compatibility with earthquake effects;

robustness and reliability: the handling system must notably be adapted for a functional life of 60 years;

ease of maintenance, notably in a hot cell;

compactness: since the handling has to be done notably in a hot cell, the tool must not exceed a certain bulk, notably a certain given height;

compatibility with the complementary handling means (winch, hoist, bridge, in-cell articulated handling arms).

In other words, the handling system must address the functions of exhibiting a high contact temperature, of the order of 150° C., and a weight of the order of 600 kg, while satisfying the safety and compactness constraints.

A handling system is known from the patent application FR2637411, which allows the transfer of nuclear fuel assemblies, for a fast neutron nuclear reactor. The system is a rectilinear transfer beam for transferring nuclear fuel assemblies, comprising a vertical guide tube in which a handling grab slides, characterized by the fact that supply means are provided for conveying a coolant into a top part of the guide tube, in order for this liquid to flow by gravity in an assembly suspended from the grab and placed in the guide tube.

This transfer beam system is primarily applicable in replacing assemblies within a fast neutron nuclear reactor: the irradiated assemblies are brought to the offloading station, from which they are discharged out of the tank of the reactor using a transfer pot filled with coolant (liquid sodium, if it is a sodium-cooled reactor) and are replaced by new assemblies by following the same path in the reverse direction. For the cooling of the irradiated assemblies with high residual power to be performed correctly upon their transfer, it is also essential for the level of the liquid metal in the tank during the handling to be such that the fissile part of the assembly remains immersed, without having to increase the height of the tank, to avoid substantially increasing the cost of the reactor as a whole. The system disclosed is therefore a transfer system designed notably for use in a fast neutron nuclear reactor.

However, this transfer beam system cannot be used, or can be used only with difficulty, to transfer an assembly into a hot cell, given the need to circulate a liquid, which is generally excluded in a hot cell. Furthermore, it is not autonomous because it is necessary to have a fluid circulation system, and above all a control rod for activating the claws of the grab so as to grasp the assembly. Finally, the circulation of a liquid in such a handling system induces inherent risks of leaks (above all when it is liquid sodium), without counting the fact that that can make said system heavier, which already has to withstand the weight of an assembly.

Furthermore, the liquid concerned is liquid sodium (whose temperature is therefore higher than 100° C.), which is generally unacceptable for a hot cell.

Also known from the patent application JPH07104094 is a system for handling a fuel assembly in a hot cell, which comprises an expansion/retraction mechanism, a gripping mechanism and a cooling mechanism. The expansion/retraction mechanism is composed of an outer tube and of an inner tube that is vertically mobile in the outer tube. The gripping mechanism is contained in the inner tube and the passage of a coolant supplied by a cooling fan is ensured. The gripping mechanism is provided with a gripping adapter suitable for securely clamping a fuel assembly, and an aperture for evacuating the coolant that has flowed in the expansion/retraction mechanism.

The cooling mechanism comprises a cooling fan which sucks the gas contained in the cell so as to cool the fuel assembly by blowing it via the expansion/retraction mechanism and the gripping mechanism. The direction of flow of the coolant goes from the cooling fan to the top of the handling system then redescends to the assembly.

The major drawback of this handling system is that it is not electrically autonomous, since it comprises a fan for blowing the gas in said system. Another drawback is the number of parts needed, which makes the system unreliable, and less compact.

Furthermore, any motorization in a hot cell, in which there are radiations, must be hardened (to avoid premature aging due to the radiations) and must in general be duplicated. Finally, this system has another drawback of disseminating all the particles in the blown gas throughout the cell. Thus, that can induce, in the cell, a dissemination of the radiological materials, deriving from the fuel pins of the assemblies if the latter prove to have failed, in other words if they have open cracks.

Also known from the patent application EP0008253 is an automatic grab with cycle for fast neutron reactor. The drawback associated with this grab is its large bulk, its significant weight. Furthermore, the docking is essentially vertical on the head of the assembly, there is no blocking system, and there is a large number of parts. The load is raised via the control element. Finally, this grab has no cooling. Thus, this grab is indeed autonomous (no actuator) but it is too bulky and has vertical docking requiring very great heights under the ceiling of the hot cell in which it operates. The large number of parts increases the probability of failure, all the more so as the load passes through a room which forms part of the control chain.

Furthermore, the abovementioned prior art solutions do not include solutions for ensuring handling safety (disconnection of an assembly for example).

The invention aims to overcome the abovementioned drawbacks of the prior art.

More particularly, it aims to have a handling device for a nuclear assembly that is capable of operating at a high temperature, autonomously, and capable of handling safely, and by meeting the abovementioned constraints, notably the safety and compactness constraints.

### SUMMARY OF THE INVENTION

One subject of the invention that makes it possible to achieve this aim is a handling device for a nuclear fuel assembly, extending along a longitudinal axis and comprising:

a body;

gripping means capable of cooperating with a fuel assembly so as to grasp or release said assembly, said gripping means being linked to the body so as to allow a relative movement between said body and all or part of the gripping means;

control means for controlling the gripping means capable of controlling said gripping means between a grasping position and a releasing position of said assembly, and vice versa;

suction means capable of generating a suction of a cooling gas through the handling device and through the assembly when it is grasped by said device.

According to an advantageous embodiment, the suction means comprise a gas flow rate booster and an intake duct for a compressed gas into said booster, said intake duct being configured so that said compressed gas entering said gas boosting device generates a suction of a cooling gas through the handling device and through the assembly when it is grasped by said device.

The compressed gas introduced into the gas flow rate booster provokes the suction of the cooling gas into the device, by Coanda effect, by venturi effect or both, which allows a highly effective cooling flow to be created.

According to a particular embodiment, the cooling gas is the ambient gas in the handling environment of the assembly, for example the gas contained in a hot cell. That allows the resources contained in the nearby environment to be used.

According to one embodiment, the gripping means comprise at least one part capable of being displaced in rotation with respect to the body and capable of cooperating with the assembly so as to grasp or release said assembly.

According to a particular embodiment, the at least one part capable of being displaced in rotation with respect to the body is a claw comprising an end capable of cooperating with a shoulder at the top end of the assembly.

According to a particular embodiment, a claw is linked to the body via an axle, said axle being substantially horizontal and extending in an orthoradial direction, so as to allow said claw to be displaced by a rotation movement about its axis with respect to the body.

According to a particular embodiment, the control means comprise at least one push-piece capable of driving at least one claw in rotation about its axle.

According to another embodiment, the gripping means comprise at least one part capable of being displaced in translation with respect to the body and capable of cooperating with the assembly so as to grasp or release said assembly.

According to a particular embodiment, the at least one part capable of being displaced in translation with respect to the body is a mechanical finger comprising a first end capable of cooperating with a shoulder at the top end of an assembly.

According to a particular embodiment, the body comprises at least one channel-like passage extending in a radial direction in which the mechanical finger can be displaced by a radial translational movement with respect to the body.

According to an advantageous embodiment, the control means comprise a bistable mechanism linked to the gripping means and capable of positioning said gripping means in a stable position of grasping or of releasing an assembly.

The bistable mechanism is used to assist in the actuation of the gripping means, without using electrical, pneumatic or electromechanical actuation. That allows for a purely mechanical actuation system, that is reliable and safe, that is to say notably allows the prevention of the possibility of a load being dropped during the handling of an assembly.

A bistable mechanism is well-suited to the cyclical operation of the handling device. Indeed, for the handling of the assemblies, the design of the handling device is such that the bistable mechanism is necessarily in one of the two states of equilibrium.

According to one embodiment, the control means comprise interaction means linked to the gripping means and capable of cooperating with an independent contact part of the handling device so that the contact between said interaction means and said independent contact part drives a movement of the gripping means.

According to a particular embodiment, the interaction means comprise an interaction crown ring.

According to an advantageous embodiment, the body comprises means capable of forming a seal with an assembly, for example an inflatable seal. That allows a gaseous flow to be provided, and thereby even a vacuum pressure in the assembly and a better cooling.

According to an advantageous embodiment, the handling device further comprises filtration means disposed downstream of the flow rate booster. That allows the dissemination of nuclear material in the cell to be avoided.

According to a second aspect, the invention relates to a handling assembly for a nuclear fuel assembly, comprising:

a handling device according to the first aspect of the invention,

a receiving support forming an independent contact part of the handling device, capable of receiving a fuel assembly and of cooperating with the handling device, so that, when the fuel assembly is positioned in the receiving support and said handling device cooperates with said receiving support, said handling device passes from a grasping position to a releasing position of an assembly, or vice versa.

According to one embodiment, the receiving support can cooperate with the interaction means of the handling device.

According to one embodiment, the handling assembly further comprises a compressed air supply circuit.

### DESCRIPTION OF THE FIGURES

Other features and advantages of the invention will become apparent from the following description given in an illustrative and nonlimiting manner, in light of the attached figures in which:

FIG. 1A illustrates a handling device according to the invention;

FIG. 1B illustrates a handling assembly according to the invention disposed in a hot cell;

FIG. 2 illustrates a first exemplary embodiment of a handling device;

FIG. 3 illustrates a second exemplary embodiment of a handling device;

FIGS. 4A to 4C illustrate a third exemplary embodiment of a handling device, seen respectively in open position (claws not separated) engaged with a handling bridge, and in closed position (claws separated);

FIGS. 5A to 5J illustrate the operation of a bistable mechanism according to the invention;

FIGS. 6A and 6B illustrate a fourth exemplary embodiment of a handling device;

FIGS. 7A and 7B illustrate a fifth exemplary embodiment of a handling device;

FIGS. 8A to 8H illustrate the kinematics of a handling device.

### DETAILED EXPLANATION OF PARTICULAR EMBODIMENTS

Throughout the present application, the handling device 1 extends in a longitudinal direction Z.

Throughout the present application, the terms “bottom”, “top”, “vertical”, “horizontal”, “raising”, “lowering”, “below” and “above” should be understood with reference to the longitudinal direction Z of the handling device 1 arranged vertically and the handling by said handling device from above its top end, it being understood that the handling of the handling device may not be vertical. The term “radial” is to be understood with reference to a plane at right angles to the longitudinal direction Z.

The same parts bear the same references in the figures, even when they are described with reference to different exemplary embodiments.

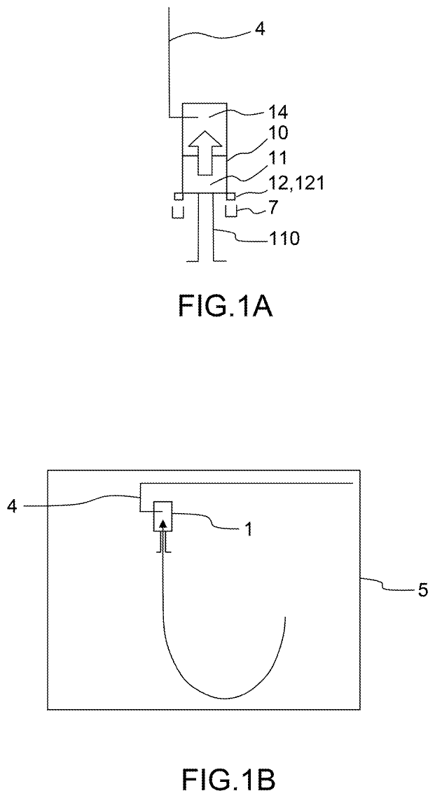

FIGS. 1A and 1B illustrate a handling assembly 100, comprising a handling device 1 according to the invention, notably disposed in a hot cell 5.

The handling device 1 is subdivided into several subsystems:

a body 10 of cylinder of revolution form;

gripping means 11 linked to the body 10 so as to be able to be displaced with respect to said body and which comprise claws 110 capable of ensuring the grasping and the releasing of a fuel assembly (not represented in these figures);

control means 12 governing the movement of the claws 110 so as to grasp or release the fuel assembly;

suction means 14 capable of generating a suction of a cooling gas through the handling device 1 and through the fuel assembly when the latter is grasped by said device.

The materials and the components of the body 10, gripping means 11, control means 12 and gripping means 14 subsystems are preferably selected according to their resistance to ionizing radiations, and to the residual thermal releases from the fuel assemblies, and to the mechanical stresses imposed by the handling.

Because of the constraints of the environment in a hot cell 5, any solution based on electric motorization for the movement of the gripping means 11 is preferably to be avoided. Indeed, the emission of ionizing radiation by irradiated fuel assemblies can seriously damage electronic systems (and particularly the windings of the motors) and requires components specific to this type of environment which prove costly (and are therefore unsuitable for a handling device). The choice of a purely mechanical system is therefore preferred.

Furthermore, it is necessary to prevent the possibility of dropping of a load during the handling of an assembly.

A so-called “bistable” mechanism is put in place.

A bistable mechanism is a mechanical system which is characterized by two stable states of equilibrium, with a possible “unstable” transition between these two states.

The bistable mechanism is used to assist in actuating the gripping means 11, without using electrical, pneumatic or electromechanical actuation. That allows for a purely mechanical actuation system, that is reliable and safe, that notably allows the possibility of dropping of the load during the handling of an assembly to be prevented.

A bistable mechanism is well-suited to the cyclical operation of the handling device. Indeed, for the handling of the assemblies, the design of the handling device is such that the bistable mechanism is necessarily in one of the two states of equilibrium. Such a mechanism will be more specifically described hereinbelow.

As stated in the introduction, it is essential to ensure the discharging of the residual thermal power from a fuel assembly. Too high a temperature rise could lead to a corruption of the materials of the cladding covering the nuclear fuel and result in a loss of containment of the radioactive substances contained in the assembly. A continuity of cooling of the assemblies while they are being handled is therefore necessary, particularly when their thermal power is high.

Suction means 14 allow this objective to be fulfilled by cooling a fuel assembly while it is being handled by the suction of a cooling gas from an aperture of the assembly. The cooling gas passes through the fuel assembly and the handling device 1. Said gas therefore allows the discharging of the residual thermal power from the fuel assembly.

The cooling gas can be the gas contained in a hot cell 5, for example nitrogen.

The handling assembly illustrated comprises:

a handling device 1;

a compressed gas supply circuit 4 (for example supplying pressurized nitrogen) for supplying the gas flow rate booster;

a receiving support 7 capable of receiving an assembly 2.

The control means 12 of the handling device 1 advantageously comprise interaction means 121 allowing cooperation with the receiving support 7. The contact between the interaction means 121 and the receiving support 7 results in the movement of the gripping means 11. That will be explained more specifically hereinafter in the present description.

A receiving support 7 can also be called “receiving station”. Several receiving supports can be disposed at different points of the hot cell 5.

The receiving support 7 can have any form, provided that it has a part capable of forming a support surface for the interaction means 121, and that it can receive all or part of an assembly.

The receiving support can be of cylindrical type, notably circular cylindrical, the assembly being received vertically.

Alternatively, it can be configured with an open form in a horizontal direction, for example in the form of a U, so as to allow a lateral reception of the assembly. This configuration allows for a minimal ceiling height, and, a fortiori, a lesser vertical travel height.

Instead of a receiving support 7, they can be other means suitable for interacting with the interaction means 121 in order to control the gripping means 11.

In FIGS. 1A and 1B, the arrows represent the direction of suction of the cooling gas (nitrogen for example) from the hot cell 5 to the handling device 1.

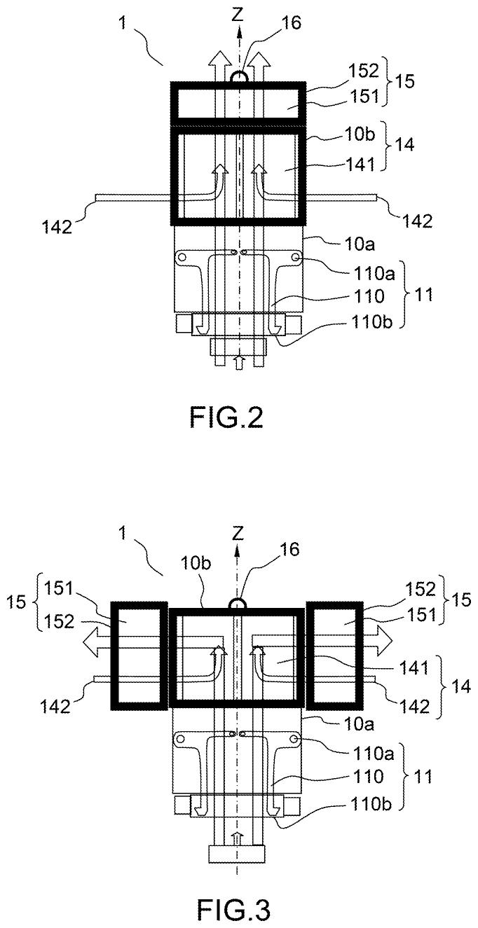

FIGS. 2 and 3 illustrate first and second exemplary embodiments of a handling device, having two different configurations of the filtration means.

The handling device 1 comprises a body 10 and gripping means 11 which comprise claws 110 capable of ensuring the grasping and the releasing of a fuel assembly (not represented in these figures), and control means (not represented in these figures) governing the movement of the claws 110.

Each claw 110 is linked to the body 10 via an axle 110a (horizontal in the example represented).

Each claw 110 further comprises an end 110b having a hook form capable of cooperating with a shoulder formed in the top part of an assembly (also called “assembly head”), so as to hook said assembly (not represented in FIGS. 2 and 3).

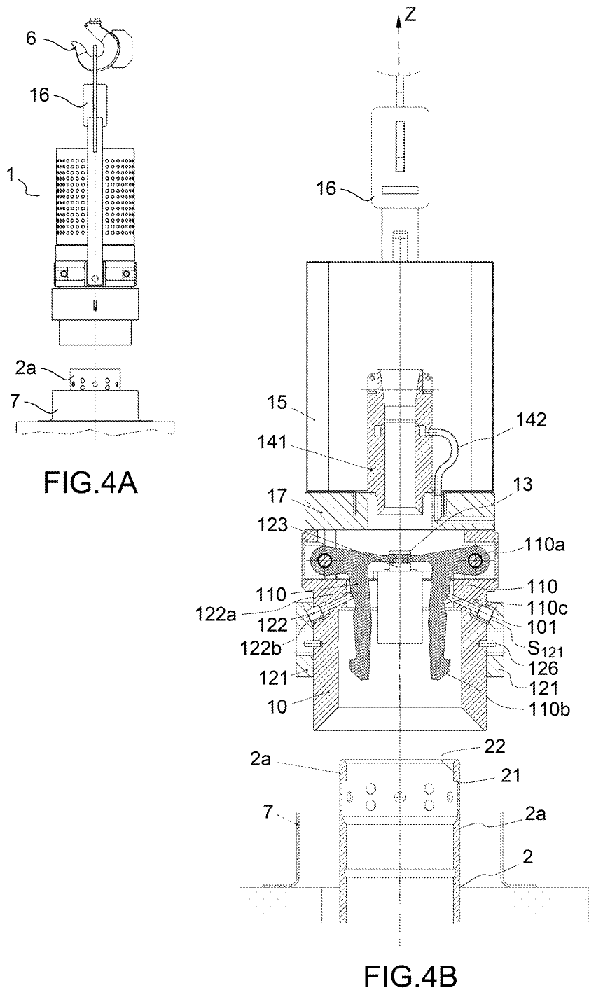

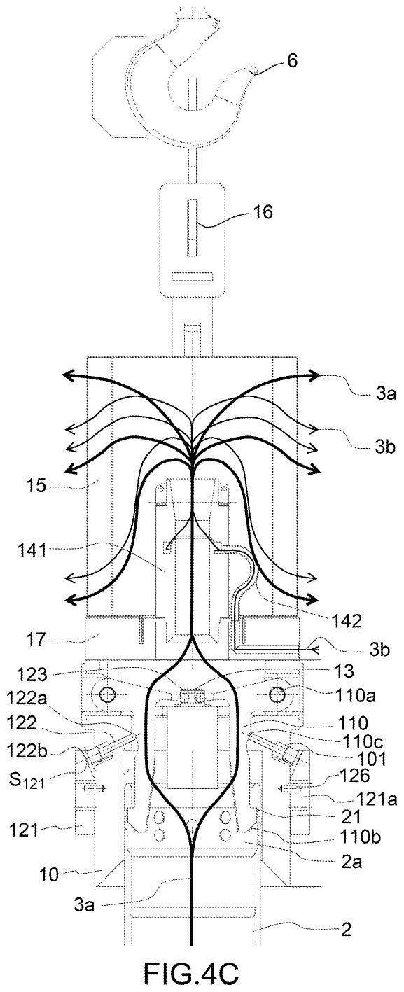

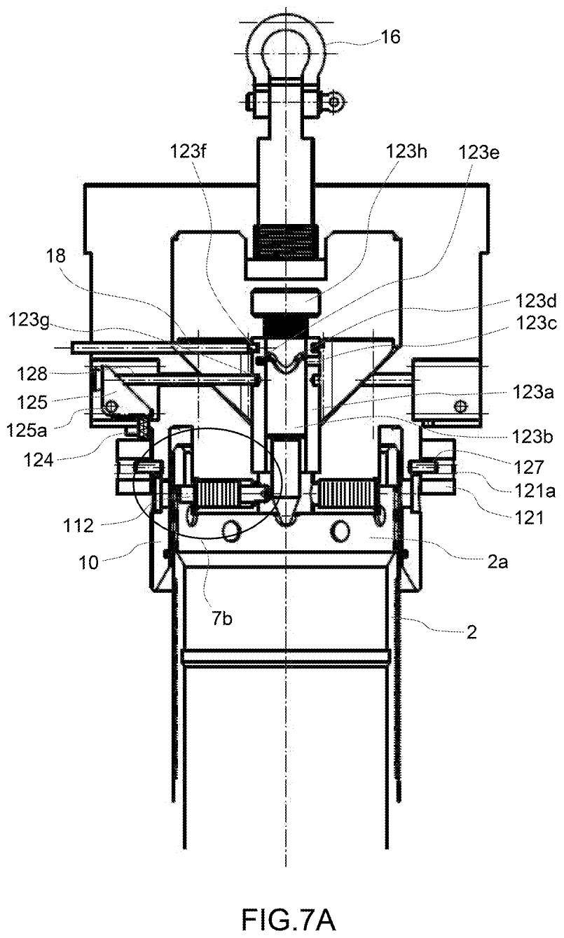

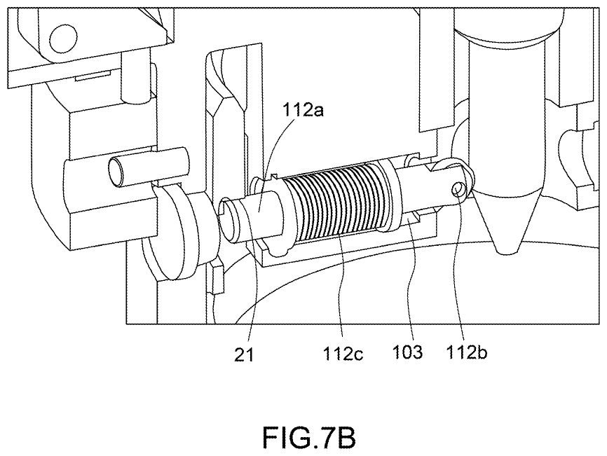

In the example illustrated, the claws 110 operate by rotation with respect to the body 10. The same gripping means are represented in FIGS. 4A-4C, 5A-5J or 6A-6B but they can be other gripping means 11 operating by rotation, or even other gripping means operating by translation, as will be explained in relation to FIGS. 7A-7B.

The handling device 1 comprises suction means 14 comprising a gas flow rate booster 141 and at least one intake 142 for a compressed gas.

Several boosters 141 can be put in place. That can allow the cooling capacity to be increased and/or a safeguard against a malfunctioning of one gas flow rate booster.

Each of these boosters 141 can be supplied via an intake 141 with dedicated compressed gas.

In the two examples illustrated in FIGS. 2 and 3, the device 1 further comprises filtration means 15 disposed downstream of the gas booster, and upstream of the outlet for the cooling gas sucked by said device, in order to trap the radioactive fission products deriving from the assemblies and potentially conveyed by said cooling gas. The filtration means represented comprise at least one filter 151 and a filtration casing 152.

The body 10 is represented in two parts, a first part 10a at the level of the gripping means, and a second part 10b at the level of the suction means.

The cooling gas represented is nitrogen. However, it could be another gas, preferably an inert gas.

In the first example, the cooling gas flow takes place in the longitudinal direction of the handling device 1, from bottom to top in the configuration illustrated: it enters into the handling device 1 through a bottom aperture of said device and it re-emerges from the device via a top aperture of said device. When an assembly is hooked onto the device, the cooling gas is sucked through an aperture in the assembly, generally a bottom aperture, typically an aperture in the foot of the assembly, and re-emerges from the assembly through the device 1, and through filtration means 15 comprising one or more filters 151, disposed in the top part of the handling device.

Above the filtration means 15, preferably above the second part 10b of the body 10 of the handling device, the filtration casing 152 being disposed inside said second part 10b, there is disposed a lifting interface 16 which can comprise a lifting loop and which allows the device 1 to be hooked by the hook of a handling bridge to be displaced, or by any other means having the same function.

One advantage of this first configuration of the filtration means 15 is that the handling device 1 does not have its radial bulk increased, only its height may increase.

As an example, the device represented has a diameter of 260 mm and a height of 650 mm.

In the second example, the cooling gas flow enters through a bottom aperture of said device and it re-emerges through one or more carefully arranged lateral apertures of said device. That can be one 360° aperture or several apertures disposed so as to avoid the rotation of the handling device which can potentially be induced by the cooling gas flow.

When an assembly is hooked onto the device, the cooling gas is sucked through an aperture in the assembly, generally a bottom aperture, and typically an aperture of the foot of the assembly, and re-emerges from the assembly through the device 1, and one or more filters 151, disposed on one or more sides of the handling device.

Above the filtration means 15, above the second part 10b of the body 10 of the handling device, the filtration casing 152 being disposed inside said second part 10b, there is disposed a lifting interface 16 comprising a lifting loop which allows the device 1 to be hooked by the hook of a handling bridge to be displaced, or by any other means having the same function.

One advantage of this second configuration is its compactness, and a lesser height compared to the first configuration.

As an example, the device represented has a diameter of 400 mm and a height of 500 mm.

Other configurations and other filtration means 15 (not represented) can be envisaged.

FIGS. 4A, 4B and 4C illustrate a third exemplary embodiment of a handling device 1, engaged with the hook of a handling bridge 6 and seen in position of releasing of the assembly, called “open” position, in which the claws are not completely separated radially (or are closer together), and in position of grasping of the assembly, called “closed” position in which the claws are radially separated.

The fuel assembly 2 can be received in a receiving support 7, as illustrated in FIGS. 4A and 4B.

The handling device 1 comprises a body 10, gripping means 11 which comprise claws 110 capable of ensuring the grasping and the releasing of a fuel assembly 2, control means 12 governing the movement of the claws 110 and suction means comprising a gas flow rate booster 141, with at least one compressed gas intake 142.

Each claw 110 is linked to the body 10 via an axle 110a (horizontal in the example represented, that is to say a plane at right angles to the longitudinal axis Z, and in an orthoradial direction). A claw can thus turn with respect to the body about its axle 110a.

As an alternative to a claw, they can be other gripping means 11 operating by rotation.

Alternatively, they can be other gripping means 11 operating by translation, as represented in FIGS. 7A and 7B.

The control means 12 of the handling device 1 are capable of controlling the movement of the claws 110.

They comprise interaction means 121 allowing cooperation with a receiving support 7.

The interaction means 121 comprise an interaction crown ring which surrounds a part of the body 10 and can slide in the longitudinal direction Z with respect to said body.

Holding abutments 126, fixed with respect to the body 10, penetrate in a radial aperture 121a of the interaction crown ring 121, for example a groove or an oblong hole. The abutments 126 allow said crown ring to be held on a given height range with respect to the body 10. In other words, the abutments 126 allow the interaction crown ring 121 to be held in low position (to prevent it from dropping) and allow a travel stop of the interaction crown ring 121 to be set in high position, corresponding to the maximum separation of the claws 110 (“closed” position, i.e. grasping position).

The abutments 126 thus allow the transmission of loads to the bistable mechanism 123 (described hereinbelow) to be limited, even eliminated.

The abutments 126 can be rods, slugs, pins, or any other parts capable of fulfilling the same functions.

The position of the holding abutments 126 is determined to ensure a translation travel of said interaction crown ring with respect to the body 10 that is necessary to ensure the control of opening and closing of the claws 110, according to the kinematics explained hereinbelow.

Several push-pieces 122, whose function is to push or release the claws 110, can be displaced in translation with respect to the interaction crown ring 121, along an inclined surface S₁₂₁ (that can also be called “inclined plane”) of said crown ring, allowing the claws 110 either to be brought radially closer together to release the assembly 2 (opening), or allowing the claws 110 to be radially separated to grasp the assembly 2 (closure).

The push-pieces 122 can be an axle, a spacer or any other part capable of pushing or releasing the claws 110 according to the displacement of the interaction crown ring 121.

Each push-piece 122 has a first end 122a capable of cooperating with a support surface 110c of a claw to push it, and a second end 122b capable of sliding over the inclined surface S₁₂₁ of the interaction crown ring 121. The push-piece 122 is inserted into an aperture 101 formed in the body 10 and can be displaced by translation in said aperture 110. When the second end 122b of a push-piece slides over the inclined surface S₁₂₁, the push-piece 122 is displaced in the aperture 101 and the first end 122a pushes the support surface 110c of the claw 110 or releases said support surface.

A push-piece 122 is associated with a claw 110. There are therefore as many push-pieces as there are claws.

Each claw 110 comprises an end 110b having a hook form capable of cooperating with a shoulder 21 formed in the top part 2a of an assembly (also called “assembly head”), so as to hook said assembly.

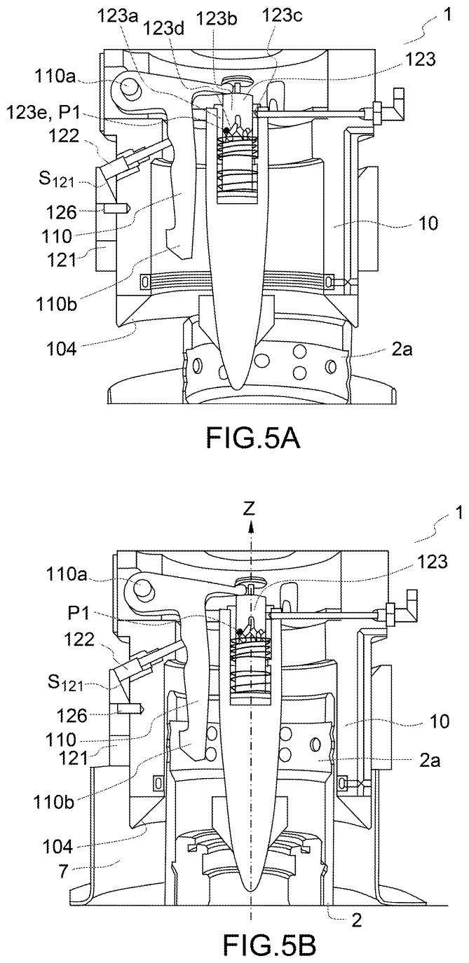

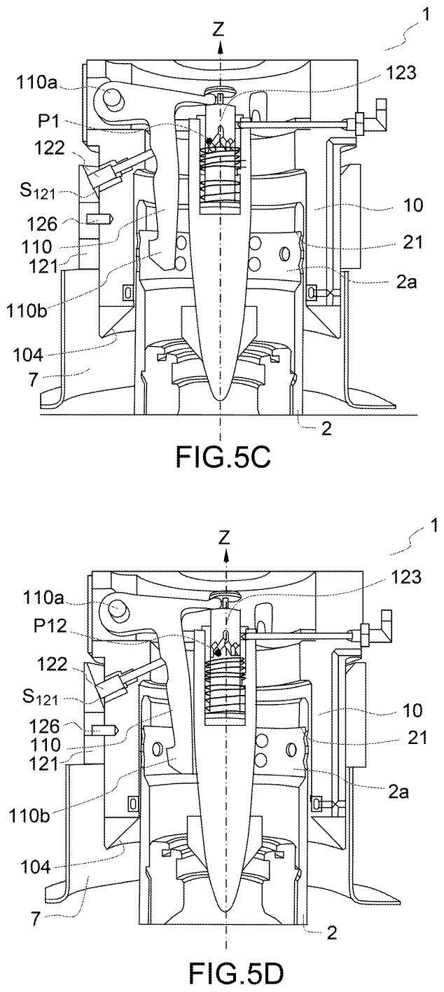

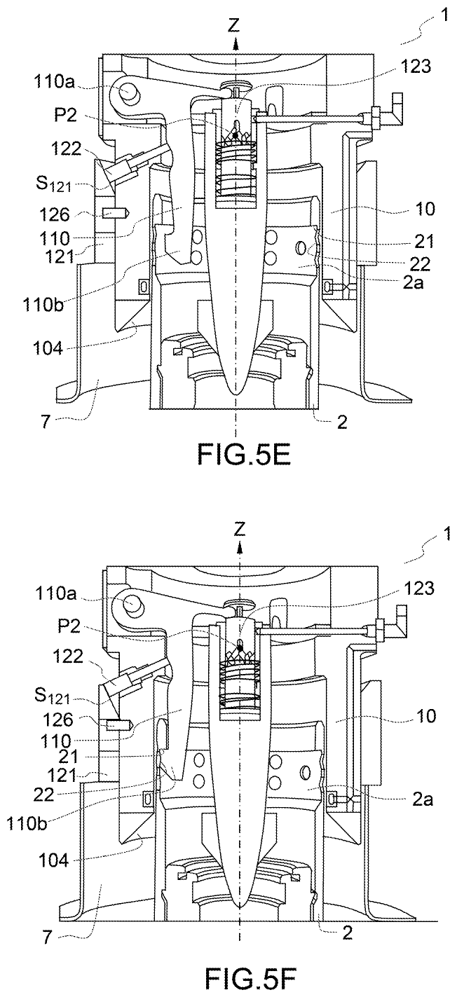

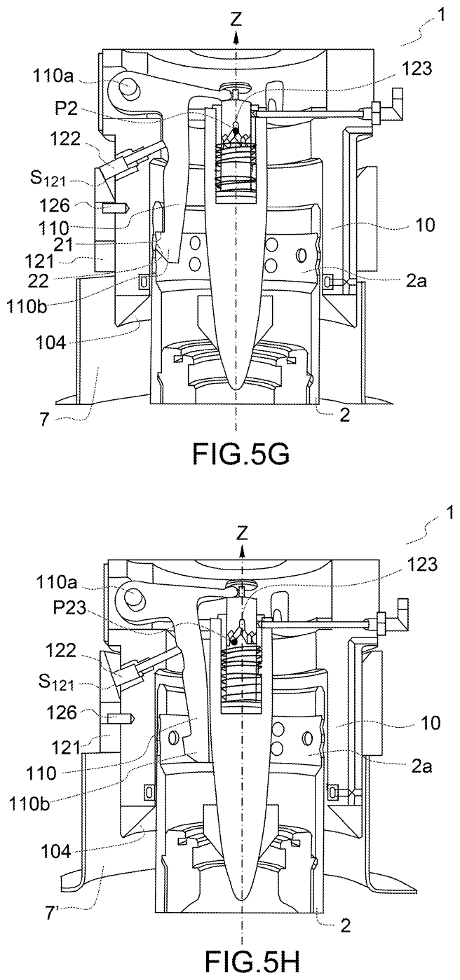

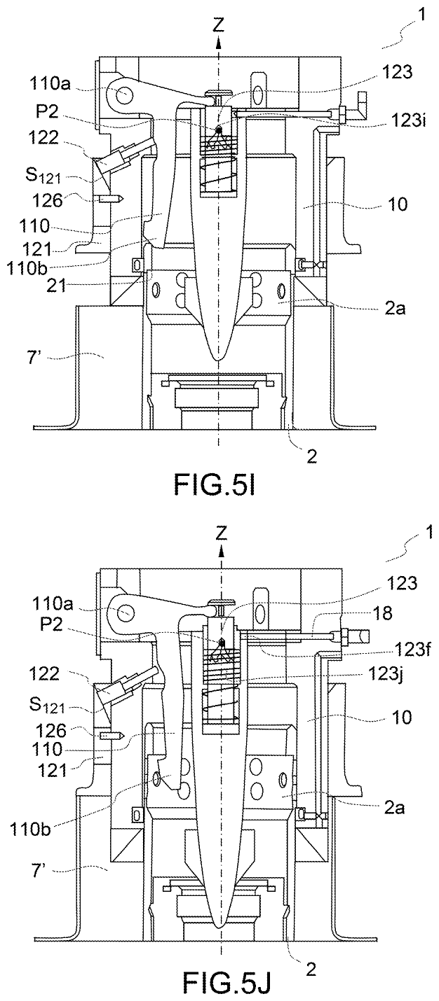

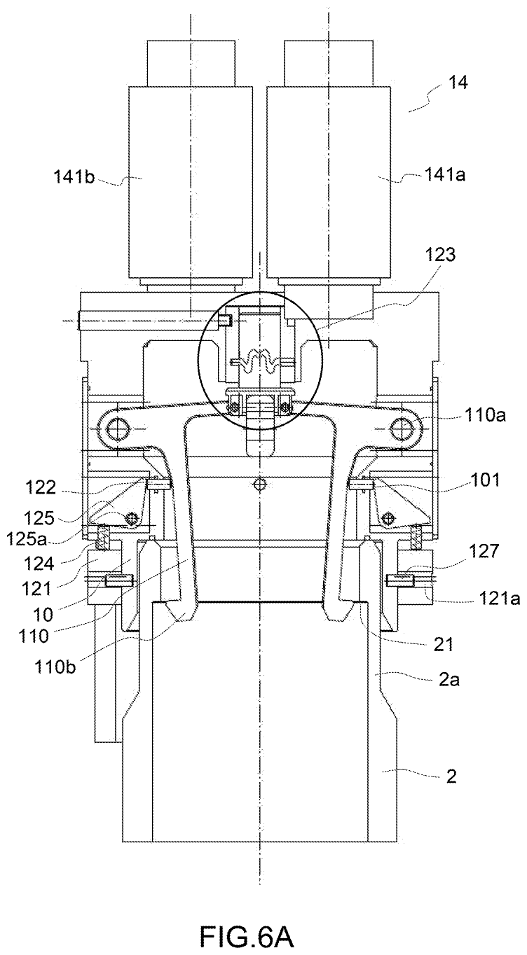

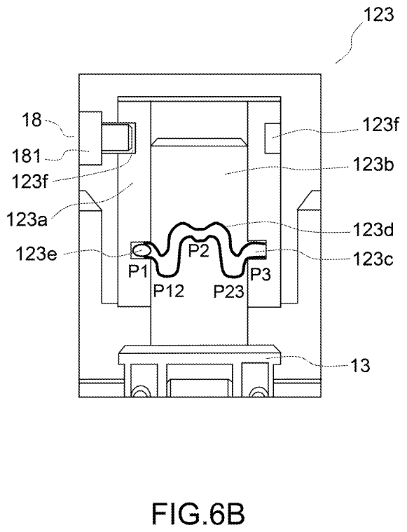

The handling device 1 comprises a bistable mechanism 123, which can, for example, be the bistable mechanism described more specifically in the description of FIGS. 5A to 5J, or that of FIG. 6B.

The operation of a bistable mechanism is illustrated in FIGS. 5A to 5J.

Although described in relation to the third exemplary embodiment (FIGS. 4A to 4C), the operation of the bistable itself applies to all the exemplary embodiments.

A bistable mechanism comprises (see in particular FIG. 5A):

a first part 123a having a cylindrical crown ring form extending along the longitudinal axis Z and comprising a cylindrical gap 123c on its lateral internal wall;

a second part 123b linked to the claws 110, having a cylindrical form of the same axis as the first part 123a and that can be introduced wholly or partly into said first part; it comprises a groove 123d on its outer lateral surface. The second part 123b can be displaced inside the first part 123a;

a link part 123a that can extend in the cylindrical gap 123c of the first part 123a and in the groove 123d of the second part 123b, thus creating a link between the first and second parts: the movement of the second part 123b with respect to the first part 123a is a pivot-sliding movement following the trajectory of the groove 123d.

The link part is a ball in the example represented, but it can be any other part suitable for extending in the cylindrical gap 123c of the first part 123a and in the groove 123d of the second part 123b, and for thus creating a link between the first and second parts.

In FIG. 5A, the handling device 1 is in “open” position: the assembly 2 is released, the claws 110 are not separated completely and the bistable mechanism 123 is in a stable position P₁.

When the handling device 1 descends (FIGS. 5A and 5B), it self-centers on the assembly 2 at the start of travel by virtue of a chamfer 104 situated at the bottom end of the body 10. The assembly 2 is introduced into said body 10 and the interaction crown ring 121 is pushed upward by a first receiving support 7 of the assembly 2.

As illustrated in FIGS. 5C and 5D, the interaction crown ring 121 being displaced in the longitudinal direction Z upward, it displaces its inclined surface S₁₂₁ into contact with the push-pieces 122, then drives a displacement of each push-piece to the lowest part of said surface (corresponding to the end of travel of the interaction crown ring 121 arriving against the abutments 126).

Thus, as illustrated in FIG. 5D, the push-pieces 122 have brought the claws 110 closer together in an “unstable” position P₁₂ of the bistable mechanism 123 and the handling device 1 rests on the first receiving support 7. The convergence of the claws 110 ensures that the hook end 110b passes below the shoulder 21 of the assembly.

As illustrated in FIG. 5E, when the handling device 1 rises up (without having hooked the assembly 2 initially), the interaction crown ring 121 descends along the body 10 while remaining in contact with the first receiving support 7, thus releasing the push-pieces 122 which allow the claws 110 to once again separate radially under the effect of the torque generated by their own weight (possibly augmented by a spring, not represented). The bistable is driven into the stable position P₂.

As illustrated in FIG. 5F, the handling device 1 continues to rise until the hook ends 110b of the claws 110 enter into contact with the bottom surface 22 of the assembly 2 and slide along the assembly 2 until they make contact with the shoulder 21 corresponding to the moment when the top part of the interaction crown ring 121 enters into contact with the abutment 126 and moves away from the first receiving support 7.

As illustrated in FIG. 5G, the device 1 rises with the handling assembly 2 and the bistable mechanism 123 is still in stable position P₂. A vertical groove 123i formed above the point P₂ avoids any transfer of load by the bistable.

Finally, as is illustrated in FIG. 5H, the assembly 2 is deposited in a location provided with a second receiving support 7′. When the handling device 1 descends and the assembly touches the bottom of the second support 7′, said device continues to descend. The claws 110 slide along the assembly then the interaction crown ring 121 displaces the push-pieces 122 upward, to a position which allows the claws 10 to open again (to radially converge). The bistable mechanism 123 is in a new “unstable” position P₂₃.

Once the handling device is no longer in contact with the second support 7′, the bistable mechanism 123 is restored to a new “stable” position.

The weight of the handling device 1 is thus entirely supported by the second receiving support 7′, notably by using the abutments 126.

The bistable mechanism 123 has a control function controlling the opening and the closing of the claws 110, without having a mechanical support function.

Any uncompleted cycle of the bistable mechanism leads to the initial configuration of said bistable.

The offset in the horizontal direction between the axle 110a and the end 110b of the claws 110, associated with the vertical force of the load generated by the assembly 2, generates a torque on the claws. That provokes a radial force outward, for example of approximately 20% of the load. That force in closed position allows the grasping of the assembly to be secured.

In the example represented, the bistable mechanism 123 is associated (via the interaction crown ring 121 and claws 110) with a receiving support 7, 7′. The receiving support, by its contact with the interaction crown ring 121, makes it possible to act on the opening and the closing of the claws 110. The bistable mechanism 123 imposes the right configuration of the claws 110 according to the handling phase. The probability of having the claws 110 separated before being placed on the assembly, for example, is greatly reduced or even zero, by virtue of the bistable mechanism.

For the case in which the handling device fails to hook the assembly when it rises (FIG. 5I), the bistable mechanism 123 comprises a vertical groove 123i formed above each stable point allowing the bistable mechanism 123 to be rearmed. In case of an anomaly, the handling device must be relowered once again onto the assembly for said assembly to be grasped when it rises.

Furthermore, the operation of the bistable mechanism 123 dispels the possibility of having a partial engagement of the claws 110 in the shoulder 21 of the assembly 2.

Consequently, the bistable mechanism 123 limits the risk of the load being dropped.

The dimensioning of the handling device 1 is done in such a way that the stability can be achieved only for a certain level of displacement of the interaction crown ring 121 by the receiving support 7, 7′. If the level of displacement is insufficient, the raising of the device 1 can take place but the claws open again (instead of remaining closed to grasp the assembly 2) and it rises without the assembly 2 which remains in its receiving support.

Finally, the bistable mechanism 123 allows the holding of the assembly 2 by the handling device 1 to be guaranteed in the event of a fault in the receiving support. Indeed, a fault in a receiving support makes the releasing of the assembly 2 impossible, because then the descent of the device 1 is incomplete.

To remedy the case of impossibility of releasing the assembly (case illustrated in FIG. 5J), a control lever 18 (also represented in FIG. 6B) allows, by being removed from a gap 123f formed in the first part 123a of the bistable mechanism, the releasing of said bistable mechanism which will be actuated by the compression spring 123j once the assembly is deposited on a receiving support. In the event of untimely maneuvering of this lever 18 under load, that would have no influence on the holding of the load (because of the radial force of 20% of the load opposing it).

The handling device 1 (FIGS. 4B and 4C) comprises suction means 14 comprising a gas flow rate booster 141 and an intake 142 (and preferentially two intakes for greater dependability) for a compressed gas.

The cooling gas is represented in FIG. 4C by thick arrows 3a. The compressed gas is represented by the thin arrows 3b.

The handling device 1 further comprises filtration means 15 disposed upstream of the gas outlet of the device and downstream of the booster 141. An intermediate part 17 accommodates and holds the filtration means 15 and the gas flow rate booster 141 and serves also as interface between the body 10 and said filtration means 15. The intake of compressed gas 142 passes partly into the intermediate part 17.

The body 10 and the intermediate part 17 can be two parts as represented, or a single part in two pieces.

As represented in FIG. 4C, when the handling device 1 and the assembly 2 are paired, the compressed gas introduced into the gas flow rate booster 141 provokes the suction of the cooling gas into the device, by Coanda effect, by venturi effect or both (flow of cooling gas represented by the thick arrows 3a).

The control means 12 and the gripping means 11 allow such a flow (in other words, they do not prevent it).

The cooling gas is sucked through an aperture in the assembly 2, generally a bottom aperture, then passes through the body of the handling device 1, then the gas flow rate booster 141, and one or more filters 151 before leaving the handling device 1.

In order to ensure a gas flow, and thereby even a maximum vacuum pressure in the assembly, a seal (not represented) can be disposed between each push-piece 122 and the aperture 101 of the body in which the push-piece is disposed. Furthermore, an inflatable seal (not represented) can be disposed between the body 10 and the head 2a of the assembly 2; the inflatable seal is deflated when the assembly passes into the body 10 to avoid damage to it.

The handling device 1 illustrated in FIGS. 4A to 4C also comprises a lifting interface 16 which can comprise a lifting loop allowing the device to be hooked by the hook 6 of a handling bridge to be displaced, or by any other means having the same function.

The lifting loop can advantageously comprise hook stabilization means capable of keeping the hook vertical, to prevent the handling device from becoming unhooked or being greatly tilted. The lifting loop can also comprise means capable of limiting impacts in the bridge raising and lowering movements.

FIGS. 6A to 6B illustrate a fourth exemplary embodiment of a handling device 1, according to different views and kinematics.

As for the third example, the handling device 1 comprises a body 10, and gripping means 11 which comprise claws 110.

Each claw 110 comprises an end 110b having a hook form capable of cooperating with a shoulder 21 formed in the top part 2a of an assembly 2, so as to hook said assembly.

In the example illustrated, and as in the third exemplary embodiment, the claws 110 operate by rotation with respect to the body 10 of the device, about their axles 110a.

They can be other parts and/or other gripping means 11 operating by rotation, or even other gripping means operating by translation.

The control means 12 of the handling device 1 are capable of controlling the movement of the claws 110. They comprise interaction means 121 allowing cooperation with a receiving support 7.

As in the third exemplary embodiment, the interaction means 121 comprise an interaction crown ring which surrounds a part of the body 10 and can slide along the longitudinal axis with respect to said body. Other parts of the control means differ however from the third example.

Linked parts 127 penetrate into a radial aperture 121a of the interaction crown ring 121 and into the body 10 and allow said crown ring and said body to be securely held. The link parts 127 can be holding abutments, slugs, rods, pins or any other parts capable of keeping the crown ring and the body mechanically secured.

Push-pieces 122 allow, as for the third example, the claws 110 to be pushed to a greater or lesser extent, allowing the claws 110 to be either brought radially closer together to release the assembly 2 (opening), or the claws 110 to be radially separated to grasp the assembly 2 (closure).

Each push-piece 122 can be displaced in translation in an aperture 101 formed in the body 10, and is also attached to a part 125 capable of transforming a vertical movement into a horizontal movement, such as a camera, a lever, a part comprising an inclined plane. Hereinbelow, said part 125 will be called lever, it being understood that it can be any other part fulfilling the same function.

Each lever 125 is linked to the body 10 by a rotation axle 125a. The rotation axle 125a is horizontal and extends in an orthoradial direction, such that each lever 125 can be displaced in rotation with respect to the body 10. Each lever is linked to the interaction crown ring 121 via a spring 124.

There is a push-piece 122, a spring 124 and a lever 125 for each claw, and they are therefore linked to the body 10 via the rotation axle 125a of each lever 125. Likewise, each claw 110 is linked to the body 10 via its rotation axle 110a.

A bistable mechanism 123 is described more specifically in FIG. 6B. It is similar to that of the third exemplary embodiment. The bistable mechanism 123 is linked to the claws 110 by a link means 13 and comprises several parts:

a first part 123a capable of rotating about the body 10 on the longitudinal axis Z and having a cylindrical crown ring form extending along said longitudinal axis: it comprises a cylindrical gap 123c on its lateral internal wall and a gap 123f on its lateral outer surface;

a second part 123b linked to the claws 110 via the link part 13 having a cylindrical form of the same axis as the first part 123a and that can be introduced wholly or partly into said first part: on its outer lateral surface along a circumference there is a groove 123d forming at least two points of stable equilibrium P₁ and P₂;

a link part 123e that can extend into the cylindrical gap 123c of the first part 123a and into the groove 123d of the second part 123b, thus creating a link between the first and second parts: thus, the movement of the second part 123b with respect to the first part 123a is a pivot-sliding movement following the trajectory of the groove 123d.

The link part 123a can be a ball, a part of oblong form, a small cylindrical part, a lug, or any other part suitable for extending into the cylindrical gap 123c of the first part 123a and into the groove 123d of the second part 123b, and for thus creating a link between the first and second parts.

When the second part 123b linked to the claws 110 is displaced under the effect of the movement of said claws, the displacement is translated by a rotation of the assembly of claws and second part to reach a stable position P₁ or P₂. Thus, when the movement is ended, the claws 110 are either in open position or in closed position, but always in a stable position, and they pass necessarily from a stable open position to a stable closed position or from a stable closed position to a stable open position.

The operation and the advantages indicated for the bistable mechanism described in the description of FIGS. 5A to 5J also apply.

In the example represented, there are four positions of stable equilibrium P₁ to P₄ (of which 3 are seen): the two positions P₂ and P₄ correspond to closed positions (assembly grasped) and the two positions P₁ and P₃ correspond to open positions (assembly released). Between two stable positions, there are unstable positions P₁₂, P₂₃, etc.

The positions of stable equilibrium constitute the physical points where the link part (ball or the like) memorizes the preceding state of equilibrium of the handling system.

The interaction crown ring 121 is capable of interacting with the receiving support 7 of an assembly.

Furthermore, the body 10 of the handling device is capable of entering into contact with the assembly 2. The contact between the body 10 and the assembly is made advantageously with a seal 102, preferably an inflatable seal.

Multiplying the number of claws (four in the example represented) allows the effectiveness of the grasping of the assembly to be guaranteed (and guarantees prevention of the situations of seizure of the assembly) in order to dispel any risk of dropping while it is being handled outside of its receiving support.

Furthermore, the device comprises an auxiliary mechanism 18 for opening the claws 110. That allows the bistable mechanism 123 to be replaced, and notably safeguards against the possible failure of the bistable mechanism 123.

The auxiliary mechanism 18 can for example comprise a rod of which one end 181 is capable of cooperating with a gap 123f formed on a lateral outer wall of the first part 123a of the bistable mechanism 123.

When the bistable mechanism is operating normally, the end 181 is disposed in the outer gap 123f and blocks the rotation of the first part 123a with respect to the body 10.

When the operation of the bistable mechanism fails, the end 181 is extracted from the outer gap 123f, which allows the rotation between the first part 123a and the body 10 to be released, and the runner link between the link part 123e and the groove 123d to be reestablished or improved.

The handling device 1 comprises suction means 14 comprising at least two gas flow rate boosters 141a and 141b and an intake 142 for a compressed gas (not represented), as illustrated in FIG. 6A, which can apply to all the embodiments.

The control means 12 and the gripping means 11 allow for the suction flow (in other words, they do not prevent it).

FIGS. 7A and 7B illustrate a fifth exemplary embodiment of a handling device, in which the gripping means 11 comprise parts operating in translation with respect to the body 10 of the handling device 1.

The handling device 1 comprises a body 10, and gripping means 11 which comprise fingers 112.

In the example illustrated, the fingers 112 operate by translation with respect to the body 10 of the device. They can be displaced in a channel-like passage 103 formed in the body 10 and extending in a radial direction. As an alternative to the fingers, they can be other gripping means 11 operating by translation with respect to the body 10.

Each finger 112 comprises a first end 112a capable of cooperating with a shoulder 21 situated in the top part 2a of an assembly 2, so as to hook said assembly. It also comprises a second end 112b and an elastic intermediate part 112c. The intermediate part 112c is an elastic part, which comprises, for example, a spring operating by compression: thus, the finger 112 is retracted radially at rest and is extended radially when it is actuated by compression.

The handling device 1 comprises a lifting interface 16, for example in the form of a lifting loop, capable of cooperating with the hook of a handling bridge or any means having the same function (not represented).

The device 1 comprises a bistable mechanism 123 comprising the following parts:

a first part 123a capable of rotating with respect to the body 10 about the longitudinal axis Z and having a crown-ring form and extending along the longitudinal axis Z: it comprises a cylindrical gap 123c on its lateral internal wall, a first outer gap 123g and a second outer gap 123f on its lateral outer wall;

a second part 123b that is mobile with respect to the first part 123a, having a cylindrical form of the same axis as the first part 123a, comprising, on its outer lateral surface along a circumference, a groove 123d forming at least two points of stable equilibrium P₁ and P₂ and comprising a top end 123h, forming a head below which a spring acts by compression on the longitudinal axis;

a link part 123e, secured to the first part 123a, capable of extending into the cylindrical gap 123c of the first part 123a and into the groove 123d of the second part 123b, thus creating a link between the first and second parts: thus, the movement of the second part 123b with respect to the first part 123a is a pivot-sliding movement following the trajectory of the groove 123d.

The second end 112b of each finger 112 can be pressed into contact with the second part 123b, notably by virtue of its resilient intermediate part 112c.

The other control means 12 are similar to those of the fourth exemplary embodiment and comprise an interaction crown ring 121 which surrounds a part of the body 10 and can slide along the longitudinal axis with respect to said body.

Link parts 127 penetrate into a radial aperture 121a of the interaction crown ring 121 and into the body 10 and allow said crown ring and said body to be held together. The link parts can be slugs, rods, pins, or any other parts capable of keeping the crown ring and the body mechanically secured.

Locking rods 128 can cooperate with the first outer gap 123g of the first part of the bistable mechanism 123, so as to lock the first part 123a which can thus no longer turn with respect to the body 10. The locking rods 128 can lock or unlock the bistable mechanism.

Each locking rod 128 is attached to a part 125 that can transform a vertical movement into a horizontal movement, such as a cam, a lever, a part including an inclined plane. Hereinbelow, said part will be called lever, it being understood that it can be any other part fulfilling the same function.

The lever 125 is linked to the crown ring 121 via a spring 124. As an alternative to a spring, it can be a spring, an axle, a spacer or any other part capable of pushing or releasing the lever 125 according to the displacement of the crown ring 121.

The lever 125 is attached to the body 10 via its rotation axle 125a.

The interaction crown ring 121 can interact with the receiving support 7 of an assembly.

When the receiving support 7 and the interaction crown ring 121 are in contact, the interaction crown ring 121 rises by driving the push-piece 122. The push-piece 122 in turn drives the lever 125 in rotation, which drives the locking rod 128 so that said rod comes out of the first outer gap 123g: thus the bistable mechanism 123 is unlocked.

The lifting interface 16 comes into contact with the top end 123h of the second part 123b of the bistable mechanism, pushes it downwards and drives it in rotation because of the pivot-sliding link between the link part 123e and the groove 123d.

The advantages indicated for the bistable mechanism in the description of FIGS. 5A to 5J which are described with reference to claws 110 apply to the handling device 1 with the fingers 112 instead of claws.

In the example represented, there are four stable positions (of which 3 can be seen): two stable positions correspond to open positions (assembly grasped) and two other stable positions correspond to closed positions (assembly released).

Multiplying the number of fingers 112 allows the effectiveness of the grasping of the assembly to be guaranteed (and prevents the situation of partial seizure of the assembly) in order to dispel any risk of being dropped while it is being handled.

For example, there are 4 fingers. That also safeguards against the failure of a finger.

Furthermore, the device 1 comprises an auxiliary mechanism 18 for actuating the fingers 112. That allows the bistable mechanism 123 for actuating the handling device 1 to be replaced, and notably safeguards against a possible failure of the bistable mechanism 123. A compression spring 123j (not represented in FIGS. 7A and 7B, but equivalent to that which can be seen in FIG. 5A) placed between the first part 123a of the bistable mechanism and the body 10 is necessary to assist in releasing the fingers.

The auxiliary mechanism 18 can comprise, for example, a rod, of which one end 181 can cooperate with an outer gap 123f formed on a lateral outer wall of the first part 123a of the bistable mechanism 123. When the bistable mechanism is operating normally, the end 181 is disposed in the outer gap 123f and blocks the rotation of the first part 123a with respect to the body 10. When the operation of the bistable mechanism has failed, the end 181 is retracted from the outer gap 123f, which allows the rotation between the first part 123a and the body 10 to be released, and the runner link between the link part 123e and the groove 123d to be reestablished or improved, in order to release the latter in the event of blockage.

The handling device 1 comprises suction means 14 comprising a gas flow rate booster 141 and an intake 142 for a compressed gas (not represented in FIGS. 7A and 7B), as represented for example in the examples previously described.

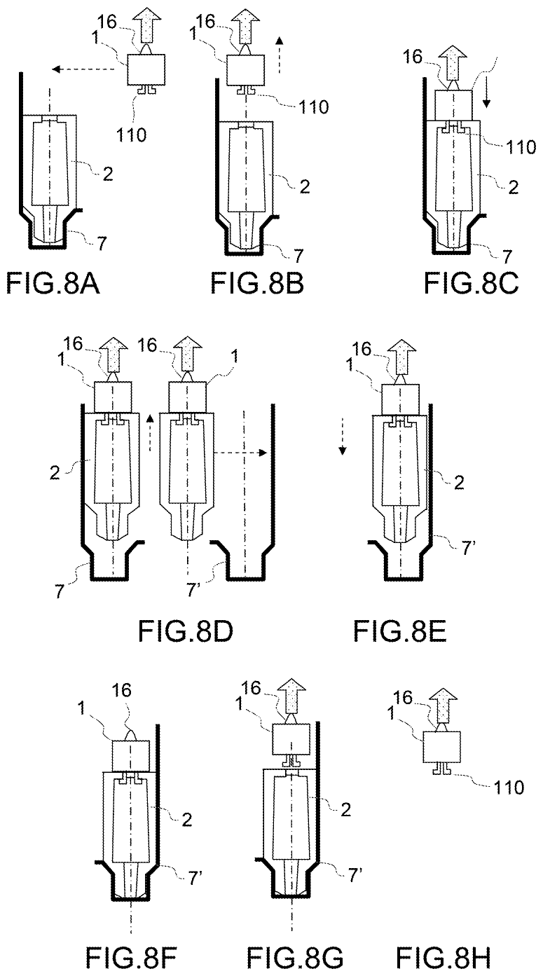

FIGS. 8A to 8H illustrate kinematics of a handling device, illustrated in 8 phases, which can be applied to all the exemplary embodiments described.

Phase 1 (FIG. 8A): with the aid of its lifting interface 16 and a handling bridge, the handling device 1 is displaced from its place of storage to the assembly 2 to be gripped, disposed in a first receiving support 7. The hooking claws (or fingers) are in open position and locked.

Phase 2 (FIG. 8B): the handling device 1 is above and on the axis of the assembly 2 to be gripped, it is ready to descend and to be paired with the receiving support 7 in which the assembly 2 is disposed. The hooking claws (or fingers) are in open position and will be unlocked by mechanical contact of the interaction means 121 of the device 1 with the first receiving support 7. The lifting interface 16 is under strain due to its own weight.

Phase 3 (FIG. 8C): the device 1 is placed on the assembly 2 and the axes of the device 1 and of the assembly 2 are aligned. The lifting interface 16 is no longer strained due to its own weight. The hooking claws (or fingers) 110 open to be positioned under a shoulder of the assembly 2, then into contact with the horizontal bottom face of said shoulder. The cooling gas flow passes from the bottom of the assembly to the top of the device, by virtue of the suction provided by the gas flow rate booster of the device 1. The lifting interface 16 rises and the bistable mechanism is locked.

Phase 4 (FIG. 8D): the assembly 2 is gripped on the device 1 and the assembly is displaced with the aid of the lifting interface 16 and a handling bridge to a second receiving support 7′. The lifting interface 16 is under strain due to its own weight and that of the assembly 2. The hooking claws (or fingers) are opened and locked in the shoulder 21 of the assembly 2.

Phase 5 (FIG. 8E): the device 1 secured to the assembly 2 arrives above the second receiving support 7′ and is ready to descend to be paired with said second support. The hooking claws (or fingers) are in closed position. The lifting interface 16 is under strain due to its own weight and that of the assembly.

Phase 6 (FIG. 8F): the device 1 secured to the assembly 2 is placed on the second receiving support 7′. The lifting interface 16 is no longer under strain due to its own weight and that of the assembly 2. The hooking claws (or fingers) are still in closed position but will no longer be in contact with the horizontal bottom face of the shoulder of the assembly and will be unlocked by mechanical contact of the interaction means of the device 1 with the second receiving support 7′.

Phase 7 (FIG. 8G): the lifting interface 16 is under strain due to its own weight. The hooking claws (or fingers) are in open position and will be locked when the device 1 rises with the aid of the lifting interface 16 and the bridge, the claws or the fingers converge (or retract).

Phase 8 (FIG. 8H): the device 1 is no longer paired with the second receiving support 7′. It is displaced with the aid of the lifting interface 16 and the bridge to its place of storage. The lifting interface 16 is under strain due to its own weight. The hooking claws (or fingers) are in open position and locked.

When the handling device 1 and the assembly 2 are paired, the compressed gas is introduced into the gas flow rate booster 141, which provokes the suction of the cooling gas into the device, by Coanda effect, or by venturi effect or both.

The assembly of the gripping means 11 and of the control means 12 described allow the suction of the gas through the handling device.

Instead of a receiving support 7, the interaction means 121 and/or the bistable mechanism 123 can interact with other receiving means in order to control the gripping means 11.

According to the invention, other control means 12 can be envisaged for controlling the gripping means 11.

Furthermore, the gripping means and the control means can be used without the suction means. In other words, the handling device can comprise only:

a body;

gripping means capable of cooperating with a fuel assembly so as to grasp or release said assembly, said gripping means being linked to the body so as to allow a relative movement between said body and all or part of the gripping means;

control means of the gripping means capable of controlling said gripping means between a position of grasping and a position of releasing of said assembly, and vice versa.

Finally, the various exemplary embodiments presented can be combined with one another.

Finally, the present invention is not limited to the embodiments previously described but extends to any embodiment lying within the scope of the claims.

1. A handling device for a nuclear fuel assembly, extending along a longitudinal axis and comprising:
a body;
gripping means capable of cooperating with a fuel assembly so as to grasp or release said assembly, said gripping means being linked to the body so as to allow a relative movement between said body and all or part of the gripping means;
control means for controlling the gripping means capable of controlling said gripping means between a grasping position and a releasing position of said assembly, and vice versa;
suction means capable of generating a suction of a cooling gas through the handling device and through the assembly when it is grasped by said device, the suction means comprising a gas flow rate booster and an intake duct for a compressed gas into said booster, said intake duct being configured so that said compressed gas entering into said gas booster device generates a suction of a cooling gas through the handling device and through the assembly when it is grasped by said device.

2. The device as claimed in claim 1, the cooling gas being the ambient gas in the handling environment of the assembly, for example the gas contained in a hot cell.

3. The device as claimed in claim 1, the gripping means comprising at least one part capable of being displaced in rotation with respect to the body and capable of cooperating with the assembly so as to grasp or release said assembly.

4. The device as claimed in claim 3, the at least one part capable of being displaced in rotation with respect to the body being a claw comprising an end capable of cooperating with a shoulder at a top end of the assembly.

5. The device as claimed in claim 4, each claw being linked to the body via an axle, said axle being substantially horizontal and extending in an orthoradial direction, so as to allow said claw to be displaced by a rotational movement about its axle with respect to the body.

6. The device as claimed in claim 5, the control means comprising at least one push-piece capable of driving at least one claw in rotation about its axle.

7. The device as claimed in claim 1, the gripping means comprising at least one part capable of being displaced in translation with respect to the body and capable of cooperating with the assembly so as to grasp or release said assembly.

8. The device as claimed in claim 7, the at least one part capable of being displaced in translation with respect to the body being a mechanical finger comprising a first end capable of cooperating with a shoulder at a top end of an assembly.

9. The device as claimed in claim 8, the body comprising at least one channel-like passage extending in a radial direction in which the mechanical finger can be displaced by a radial translational movement with respect to the body.

10. The device as claimed in claim 1, the control means comprising a bistable mechanism linked to the gripping means and capable of positioning said gripping means in a stable position of grasping or releasing an assembly.

11. The device as claimed in claim 1, the control means comprising interaction means linked to the gripping means and capable of cooperating with an independent contact part of the handling device so that the contact between said interaction means and said independent contact part drives a movement of the gripping means.

12. The device as claimed in claim 11, the interaction means comprising an interaction crown ring.

13. The device as claimed in claim 1, the body comprising means capable of forming a seal with an assembly, for example an inflatable seal.

14. The device as claimed in claim 1, further comprising filtration means disposed downstream of the flow rate booster.

15. A handling assembly for a nuclear fuel assembly, comprising:
a handling device as claimed in claim 1,
a receiving support, forming an independent contact part of the handling device, capable of receiving a fuel assembly and of cooperating with the handling device, so that, when the fuel assembly is positioned in the receiving support and said handling device cooperates with said receiving support, said handling device passes from an assembly grasping position to a releasing position, or vice versa.

16. The handling assembly as claimed in claim 15, the receiving support being capable of cooperating with the interaction means of the handling device.

17. The handling assembly as claimed in claim 15, further comprising a compressed air supply circuit.
